(19) United States
(12) Patent Application Publication
(10) Pub. No.: US 2007/0217505 A1
(43) Pub. Date: Sep. 20, 2007

(54) Adaptive Decoding Of Video Data

(75) Inventor: Martin Samuel Lipka, Ormond (AU)

Correspondence Address: SHERIDAN ROSS PC, 1560 BROADWAY, SUITE 1200, DENVER, CO, 80202, US

(73) Assignee: VIVIDAS TECHNOLOGIES PTY LTD, St. Kilda Victoria (AU)

(21) Appl. No.: 11/569,606

(22) PCT Filed: May 27, 2005
(86) PCT No.: PCT/AU05/00756

§ 371 Date: Nov. 27, 2006

(30) Foreign Application Priority Data
May 27, 2004 (AU) 2004902844

(51) Int. Cl. H04N 7/26

(52) U.S. Cl. 375/240.02

(57) ABSTRACT

The invention relates to the field of data processing, for processing a stream of data comprising video data, the video data comprised in a sequence of frames. Typically, the data also comprises audio data, and optionally further multimedia data such as data relating to interactive functionality. The invention provides a method and system for playing a multimedia digital data stream comprising video data to be decoded and displayed to a user in a sequence of frames, including the steps of: receiving and decoding the video data; monitoring a decoding parameter; applying a post-processing algorithm to decoded video frames; aid displaying the resulting frames on a display device; wherein the post-processing algorithm applied is continuously adapted in accordance with said decoding parameter.

### FIELD OF THE INVENTION

The present invention concerns the decoding of video data in a data stream, and in particular relates to provision of adaptive decoding of video data, or dynamic adjustment of the video decoding process. It has particular application to multimedia web streaming applications.

### BACKGROUND OF THE INVENTION

In this specification, where a document, act-or item of knowledge is referred to or discussed, this reference or discussion is not an admission that the document, act or item of knowledge or any combination thereof was at the priority date part of common general knowledge, or known to be relevant to an attempt to solve any problem with which this specification is concerned.

In broad terms, the invention relates to the field of data processing, for processing a stream of data comprising video data (and typically also comprising audio data, and optionally further multimedia data such as data relating to interactive functionality), the video data comprised in a sequence of frames.

In order to preserve synchronisation between audio and video data, it is necessary to make adjustment to the transfer rate of the stream of data, so that a specified video presentation time is synchronised with a reference time, such as the correct moment in time of the associated audio stream. The data stream is organised in frames of data fed through a processing device, and a processing unit within the processing device is provided with means for determining the synchronisation.

The MPEG standard (from the Motion Pictures Expert Group (MPEG)) is a well established standard for audio and video compression and decompression algorithms, for use in the digital transmission and receipt of audio and video broadcasts. This provides for the efficient compression of data according to an established psychoacoustic model to enable real time transmission, decompression and broadcast of high quality sound and video images. Other audio standards have also been established for the encoding and decoding of audio and video data transmitted in digital format, such as data for digital television systems.

Compression standards are based on psycho-acoustics of human perception. Generally, video and audio need to match to an accuracy of not much worse than 1/20 of a second in order to be acceptable for the viewer. Accuracy worse than 1/10 of a second is usually noticeable by the viewer, and accuracy of worse than ⅕ of a second is almost always noticeable.

Maintaining synchronisation between video and audio data is a straightforward matter if the streams are integrated and played using a single video/audio source. This is not the case for digital video, as the audio data and the video data are separated and independently decoded, processed, and played. Furthermore, computer users may require to view digital video while performing some other task or function within the computer, such as sending or receiving information from a computer network. This is quite possible in a multitasking computing environment, and can introduce significant multimedia synchronisation problems between the audio and the video data.

The use of compression techniques such as MPEG requires the multimedia data to be, decoded before it can be played, which is often a very computer-intensive task, particularly with respect to the video data. In addition, competing processes may steal away processing cycles of the central processor, which dynamically affects apparent processing power of the machine. This has the result that the ability to read, decode, process, and play the multimedia data will vary during the processing, which can affect the ability to synchronously present the multimedia data to the user.

The prior art has developed a number of ways to tackle this problem. One simple solution is to alter the speed of the audio data to match that of the video data. However, audio hardware does not generally support simple alterations in the audio rate, and in any case varying the audio rate produces a result generally unpleasant to the viewer, such as wavering alterations in pitch, deterioration in speech, etc. For this reason, the audio data is generally taken as providing the standard of player time, and the video is made to keep pace with it.

A further approach is simply to increase the performance level of the hardware, to ensure that the intensive computing requirements are met, and synchronisation of the audio and video can therefore be maintained. However, in applications of multimedia streaming to client browsers, the system has no control over the processing power (or over the simultaneous competing needs) of individual machines. It is therefore important that the synchronisation processes are as performance-tolerant as possible.

Other solutions of the prior art have included the dropping of frames of video data to maintain synchronisation with the audio data. However, in terms of viewer experience, this technique is very much a compromise, as the result can be typically jerky in appearance.

It is also important that sufficient processor time is devoted to the audio decode and play process to avoid intrusive and undesirable breaks (pops and silences) in the sound stream.

Multimedia communications is, of course, a rapidly developing field. Recent advances in both the computer industry and telecommunications field has made digital video and audio economically viable for visual communications, supported by the availability of digital channels such as ISDN, satellite and wireless networks, and digital terrestrial broadcasting channels. This has led to increasing applications in communication-based applications such as video phone, video conference systems, digital broadcast TV/HDTV, remote sensing, medical diagnostics, customer support, and surveillance, as well as audio visual applications in server-client based systems, such as education, video-on-demand entertainment, and advertising. In web streaming applications, video data streams from stored video clips at a server are provided to a client machine, without the need to store the data at the client before displaying.

Video and audio signals are amenable to compression due to considerable statistical redundancy in the signals, and effective digital compression and decompression techniques have been developed, able to deliver high quality outputs. The MPEG standard, discussed above, is one such compression technique. As is well understood, such compression techniques rely on correlation between neighbouring samples in a single video frame, and successive samples over time, respectively ‘spatial correlation’ and ‘temporal correlation’.

A digital video frame must typically be decoded, decompressed, processed and displayed in 1/25s in order to avoid falling behind the audio stream. The processing is generally very CPU-intensive, and (as mentioned hereinbefore) the speed of this operation therefore depends on the capability of the available machine resources, which can be subject to considerable dynamic variation, due firstly to the quantity of data in each individual frame, and secondly on competing demands on the machine used.

In a multimedia processor a codec device is used to convert the digital signal to an analogue system for playing on a user's machine. Typically, for video playback, the codec includes means for post-processing of each video frame to reduce artifacts that have been introduced by the decoding algorithm, artifacts that would otherwise have a possibly perceivable effect on the quality of the displayed image. There are a variety of commonly used post-processing algorithms suitable for this step, but typically the post processing is applied on a per-pixel basis, and the process therefore depends on the number of pixels in each frame treated.

### SUMMARY OF THE INVENTION

The present invention aims to at least partially address the inconveniences of the prior art mentioned above, and to this end there is provided a method for playing a multimedia digital data stream comprising video data to be decoded and displayed to a user in a sequence of frames, including the steps of:
monitoring a decoding parameter;
applying a post-processing algorithm to decoded video frames;
displaying the resulting frames on a display device;

wherein the post-processing algorithm applied is continuously adapted in accordance with said decoding parameter.

Preferably, the method includes passing frames to a buffer once they have been decoded, the decoding parameter representing the number of frames stored in the buffer.

Preferably, the post processing algorithm involves applying one or more filters to the decoded video data, and the step of adapting the algorithm comprises reducing the level of filtering and/or the number of filters applied in accordance with the number of frames stored in the buffer.

Preferably, when the decoding parameter reaches a certain first value (eg, the number of frames in the buffer reduces to a certain first number), the applied post processing reduces to zero, meaning that no post processing algorithm is applied. If the decoding parameter changes further (eg the number of frames in the buffer reduces beyond this first number), the method includes the step of only decoding certain of the frames, the proportion of frames dropped depending on the value of the decoding parameter (eg number of frames stored in the buffer).

Preferably, the multimedia digital data stream also comprises audio data to be decoded and provided to a user, the sequence of frames of video data displayed in time synchronisation with said audio data provided, the method including the step of, when the decoding parameter reaches a certain second value (eg, number of frames in the buffer reduces further to a certain second number), the time synchronisation is not applied, each frame being displayed as it becomes available from the decoding step.

In a preferred embodiment, when the decoding parameter reaches said second value, one frame in every two is dropped.

Preferably, the multimedia digital data stream includes key frame data in said video data, and if the decoding parameter changes further (eg the number of frames in the buffer reduces beyond this second number), then all video frames are dropped until the next key frame is detected.

An alternative decoding parameter may be a measure of the time taken to decode a frame, the progressive actions defined above being implemented in accordance with an increase in that time.

In accordance with the invention, then, the post-processing applied to a sequence of video frames is dynamically altered in response to a measure of how successfully the video display is keeping up with the digital media stream. Typically, the media player will run a buffer of, say, 10 frames. As the buffer reduces, as a result of the machine's inability to process frames sufficiently rapidly, the post-processing is scaled back, eventually to bypass the post-processing step completely for successive frames until the buffer is re-established.

If, once the post processing has been bypassed, the frame decoding speed remains undesirably low, one or more complete frames can be skipped. Preferably, in respect of a video data stream containing key frames, the video playback can be resynchronised at the next key frame.

In accordance with a further aspect of the invention, there is provided a processor for processing a coded multimedia digital data stream comprising video data to be displayed to a user in a sequence of frames, the processor including:
a decoding module, including a decoding parameter monitor;
a post processor module;
a display module for passing the resulting frames to a display device;

wherein the post processor module is configured to operate in accordance with the output of said decoding parameter monitor.

Preferably, the processor includes a video buffer to stored a number of decoded frames, and the decoding parameter monitor comprises a means to assess the number of frames stored in said buffer.

### BRIEF DESCRIPTION OF THE DRAWINGS

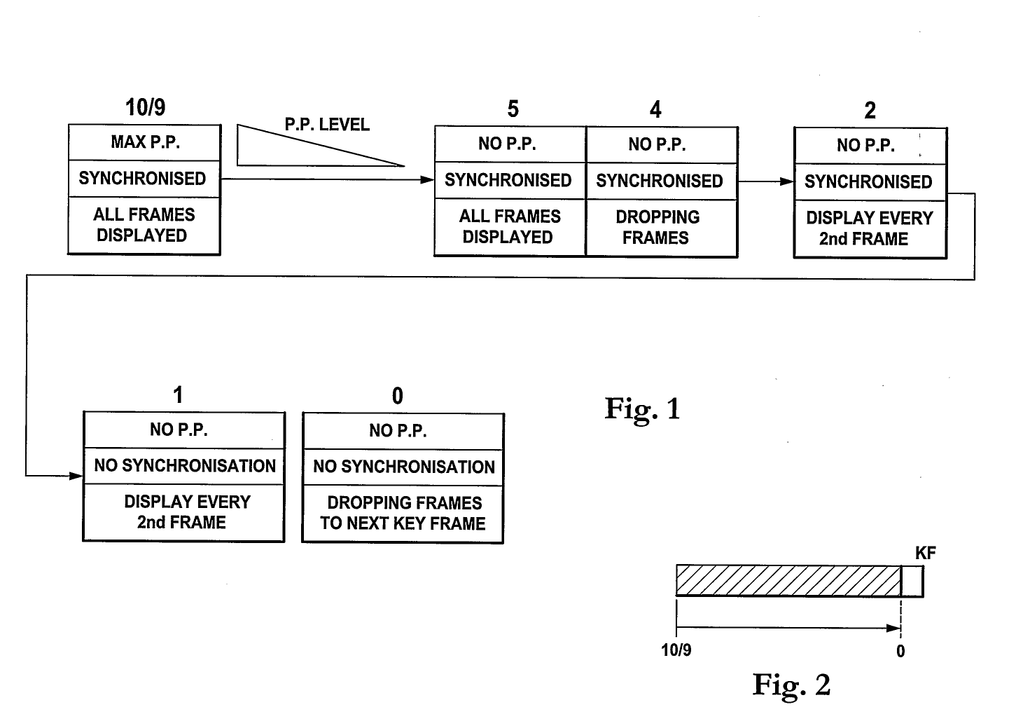

The invention will now be further explained and illustrated by reference to the accompanying drawings, in which FIGS. 1 and 2 schematically illustrate the method of the invention.

### DETAILED DESCRIPTION OF THE DRAWINGS

The present invention may be practised on any suitable computing device, with the necessary hardware and software resources for decoding and playing digital audio and video data streams. Such devices include personal computers (PCs), hand-held devices, multiprocessor systems, mobile telephone handsets, dvd players and terrestrial, satellite or cable digital television set top boxes. The data to be played may be provided as streamed data, or may be stored for playback in any suitable form.

The invention approaches the problem of insufficient machine resources to decode and play multimedia data from the point of view of user experience. In order of how noticeable to a user are distortions in audio/video playback:

1. Audio skipping, which gives rise to very undesirable pops and gaps and discontinuities, as explained above.

2. Loss of synchronisation between audio and video playback.

3. Loss of frames (if only one or a few frames are occasionally dropped).

4. Frame quality.

Video media is efficiently stored and distributed with temporal and spatial compression. It is encoded and then generated at a certain bit rate. To decode and present that media, at the best quality that the media and the decoder can produce, requires that the playback machine has a minimum amount of processing capability.

The invention provides a novel approach to dynamically adjusting frame quality as a first option if prescribed criteria indicate that the decoding and rendering being performed by the codec device are falling behind, or are likely to fall behind. Decoding and rendering may fall behind because the resources of the playing machine are engaged on other tasks, or because the machine simply lacks sufficient computing resources.

Testing of the technique of the invention shows that the overall user experience of the played audio/video stream can be maintained and some cases significantly improved, at the expense of a relatively small decrease in the quality of the displayed image.

The invention serves to afford the extraction of the highest quality user experience from a given video file, given the limitations of a decoding device not being able to perform all the calculations for optimal video display, in real time.

Multimedia playback consists of two main attributes, namely audio and video. The requirements for optimal quality are defined as follows; These are listed in order of importance to user perceptions.

1. High quality video. This simply gives a high quality visual impression.

2. High frame rate. This gives a smooth quality visual impression

3. Synchronised audio and video. This gives the impression of actually watching “a video”

4. Continuous audio. This gives the impression of watching a presentation.

The playback architecture must contain the following features to support this method:

Post Processing

Modern video codecs (employing spatial compression) produce decoded frames with known aberrations. These aberrations are described as artifacts, and are usually introduced due to lower bit rate encoding. The artifacts are not introduced intentionally:

they are a known and expected result of the encoding and decoding algorithms, and produce image effects such as ‘blocking’ or ‘ringing’. Typically, their presence can be minimised by applying various filters over the decoded frame, in order to detect these effects and to filter them out. A post processor typically consists of several layers of filters, that sequentially perform various functions, such as de-ringing, de-blocking or smoothing.

Filtering is computationally expensive. It is estimated that for some video codecs, such as VP6, de-blocking and de-ringing filtering account for upwards of 90% of the overall video processing time, as opposed to 7% spent actually decoding the video frame. Pre-Buffering

Typically, video frames are decoded in advance and buffered. This is a basic requirement for smooth quality playback, as the required processing time for a given machine to completely decode a frame of video depends on the amount of data being decoded (which is reflected in the complexity of the frame itself, such as whether or not it is a key frame), the amount of post processing occurring, and the amount of time the machine spends performing other competing tasks.

Asynchronous Video Playback

The video rendering device can operate asynchronously to the buffering device. The video rendering device plays back and displays frames from the buffer, if and only if they are available in the buffer. Otherwise they are effectively skipped.

The particular method employed involves the following:

1. A decoding quality parameter that is checked and adjusted continuously.

2. Setting the audio decoding to be the highest priority; a priority above the video.

3. Depending on the level of the decoding quality parameter, the following adjustments s to video performance are introduced:

a) As the decoding quality falls, the level of post processing falls. This has the effect of shifting processor usage from filtering to decoding in order to keep up the amount of decoded video frames in the buffer and consequently maintain smooth quality playback. This technique can be seen as a trade-off between video image quality and maintaining a continuous stream of decoded frames to assist in delivering smooth video playback.

The filter processes occurring within the codec are selectively controlled, by hooking into the codec, (such as VP6) through a well defined interface, as understood by those skilled in the art.

b) After the level of post processing is reduced to the condition that no post processing is being performed, if the decoding quality parameter falls further, the number of frames that are completely decoded and placed in the video buffer is reduced. This is reduced in an integer fashion; initially 4 of 5 are displayed, then 3 of 4, then 2 of 3, then 1 of 2 (ie every second frame). This technique can be seen as a trade-off between the number of video frames and maintaining synchronism.

The placement of frames into the video buffer is controlled through manipulation of the colour space conversion process occurring within the codec. Again, this may be controlled by hooking into the codec through a defined interface. As known to those skilled in the art, certain video compression algorithms employ a different colour space to those used by video display hardware. For example, the compression algorithms employed in the MPEG-2 standard utilise the YUV colour space, whilst graphics hardware on personal computers tend to utilise the RGB or UYUV colour spaces.

Before a decoded video frame can be displayed its colour space must be converted to that utilised by the display hardware. If this does not occur, the frame will not be placed in the video buffer. Accordingly, selective disabling and enabling of the colour frame conversion process allows the number of video frames placed in the video buffer to be controlled.

c) If the decoding machine is still unable to maintain a decode-and-display rate of one frame in every two, then the program switches from a time synchronised mode (where the correct video frame—if available—is displayed at the right time, and therefore synchronised with the audio signal), to a decoding rate-dependent mode, in which the video buffer fully decodes every second frame (as above), and the video renderer displays each frame as it becomes available. This technique can be seen as a trade-off between the video/audio synchronisation and the visual result (the desired appearance of actually watching a video presentation).

To achieve this latter mode (c), and to limit time differences between the audio and video, entire blocks of frames are dropped. When the next video frame falls due that is a key frame (a frame that does not depend on the preceding frames, ie is not temporally compressed), the video buffering jumps forward and decodes that frame, and discards the intermediate frames between the current decoding frame position, and this key frame.

Stimulus that Adjust the Decoding Quality

The initial conditions are set as follows. The initial value of the decoding parameter is determined by assessing the CPU frequency of the decoding machine. The lower the frequency, the lower the value of the initial decoding quality parameter.

The hard limits are set as follows. As the number of pre-buffered video frames drops, the value of the decoding quality parameter is forced down. This is treated in a hysteresis fashion. This means that if there are less than a certain number of pre-buffered frames, the decode quality cannot be above a certain number. Conversely, if there are a certain number of pre-buffered frames in the buffer, then the decoding quality cannot be below a certain value. There is hysteresis of float in the decoding quality parameter.

The soft adjustments are set as follows. The decoding quality is incrementally increased if the buffer is full, or if the system has jumped to a new keyframe, due to falling sufficiently far behind and carrying out step (c) above.

It should be noted that the structure of the technique of the invention provides an ability to arbitrarily adjust the settings in order to enhance the video playback performance.

The accompanying FIG. 1 diagrammatically illustrates the method of the invention, illustrating the progressive adjustment of video processing as the number of frames in the buffer reduces. If there are 10 frames in the buffer (9 stored frames plus a copy of the frame currently displayed), then maximum post processing (Max P.P.) is applied, the audio and video signals are synchronised, and all frames are displayed. As the number of frames decreases to 5 frames in the video buffer, the level of post processing applied is successively reduced, by bypassing progressive post processing layers or filters, until at 5 buffered frames no post processing is carried out. As the number of buffered frames successively further reduces, then frames are progressively dropped, from (say) dropping 1 frame in 5, to displaying just 1 frame in 2. When the video buffer empties completely, then synchronisation is abandoned, and the audio will then run ahead of the video. Finally, the video jumps to the next key frame KF, to reestablish synchronisation, as illustrated in accompanying FIG. 2.

Modifications and improvements to the invention will be readily apparent to those skilled in the art. Such modifications and improvements are intended to be within the scope of this invention.

1. A method for playing a multimedia digital data stream comprising video data to be decoded and displayed to a user in a sequence of frames, including the steps of:
decoding the video data;
monitoring a decoding parameter;
applying a post-processing algorithm to decoded video frames; and
displaying the resulting frames on a display device;
wherein the post-processing algorithm applied is continuously adapted in accordance with said decoding parameter.

2. The method of claim 1, including the step of passing the frames to a buffer once they have been decoded, wherein the decoding parameter relates to the number of frames stored in the buffer.

3. The method of claim 1, wherein die decoding parameter is a measure of the time taken to decode each frame.

4. The method of claim 1, wherein the post-processing algorithm includes the step of applying one or more filters to the decoded video data, and the step of adapting the algorithm comprises reducing the level of filtering and/or the number of filters applied in accordance with the decoding parameter.

5. The method of claim 4 wherein, when the decoding parameter reaches a first prescribed value, the applied post processing reduces to zero, such that no post processing algorithm is applied.

6. The method of claim 5 including the step of, in response to the decoding parameter reaching a second prescribed value, only a proportion of the total frames are fully decoded and passed to the video buffer for display, the proportion of frames not displayed depending on the value of the decoding parameter.

7. The method of claim 6 wherein the number of frames passed to the video buffer for display is controlled by selectively enabling and/or disabling a color space conversion process for decoded video frames.

8. The method of claim 5, the multimedia digital data stream also including audio data to be decoded and provided to a user, the sequence of frames of video data to be displayed in time synchronisation with said audio data provided, wherein the method includes the step of, when the decoding parameter reaches a certain prescribed value, the time synchronisation is not applied, each frame being displayed as it becomes available from the decoding step.

9. The method of claim 8, wherein selected frames are dropped.

10. The method of claim 1, the multimedia digital data stream including key frame data within said video data, and if the decoding parameter reaches said second value, all video frames are dropped until the next key frame is detected.

11. A system for processing a coded multimedia digital data stream comprising video data to be displayed to a user in a sequence of frames, the system including:
a decoding module, including a decoding parameter monitor;
a post processor module;
a display module for passing the resulting frames to a display device;
wherein the post processor module is configured to operate in accordance with die output of said decoding parameter monitor.

12. The system of claim 11, including a video buffer to stored a number of decoded frames, wherein the decoding parameter monitor comprises a means to assess the number of frames stored in said buffer.

13. The system of claim 11, wherein the decoding parameter monitor comprises a means to assess the time taken to decode the frames.

14. A computer software product for playing a multimedia digital data stream comprising video data to be decoded and displayed to a user in a sequence of frames, the software product including computer program code, which when executed:
decodes the video data;
monitors a decoding parameter;
applies a post-processing algorithm to decoded video frames; and
displays the resulting frames on a display device;
wherein the post-processing algorithm applied is continuously adapted in accordance with said decoding parameter.

15. The computer software product of claim 14, further including computer program code which when executed, passes the frames to a buffer once they have been decoded, wherein the decoding parameter relates to the member of frames stored in the buffer.

16. The computer software product of claim 14, wherein the decoding parameter is a measure of the time taken to decode each frame.

17. The computer software product of claim 14, wherein the post-processing algorithm applies one or more filters to the decoded video data, and wherein adapting the algorithm comprises reducing the level of filtering and/or the number of filters applied in accordance with the decoding parameter.

18. The computer software product of claim 17 wherein, when the decoding parameter reaches a first prescribed value, the applied post processing reduces to zero, such that no post processing algorithm is applied.

19. The computer software product of claim 14, further including computer program code, which when executed only fully decodes a proportion of the total frames and passes those frames to the video buffer for display, in response to the decoding parameter reaching a second prescribed value, the proportion of frames not displayed depending on the value of the decoding parameter.

20. The computer software product of claim 19 wherein the number of frames passed to the video buffer for display is controlled by selectively enabling and/or disabling a colour space conversion process for decoded video frames.

21. The computer software product of claim 14, wherein the multimedia digital data stream also includes audio data to be decoded and provided to a user, the sequence of frames of video data to be displayed in time synchronisation with said audio data provided, wherein the computer software product includes computer program code, which when executed, does not apply time synchronisation when the decoding parameter reaches a certain prescribed value, each frame being displayed as it becomes available after being decoded.

22. The computer software product of claim 21, wherein selected frames are dropped.

23. The computer software product of claim 14, the multimedia digital data stream including key frame data within said video data, and if the decoding parameter reaches said second value, all video frames are dropped until the next key frame is detected.
